(19) United States
(12) Patent Application Publication
(10) Pub. No.: US 2025/0246329 A1
(43) Pub. Date: Jul. 31, 2025

(54) SPECIAL FORM CAPSULE FOR ANNULAR TARGET ASSEMBLY FOR USE IN A RADIATION DELIVERY SYSTEM

(71) Applicant: QSA Global Inc., Burlington, MA (US)

(72) Inventors: David Wood, Waltham, MA (US); Brian Girouard, Billerica, MA (US)

(21) Appl. No.: 19/038,952

(22) Filed: Jan. 28, 2025

Related U.S. Application Data
(60) Provisional application No. 63/626,147, filed on Jan. 29, 2024.

(51) Int. Cl. G21F 5/015; G21F 1/08; G21F 5/12

(52) U.S. Cl. CPC G21F 5/015; G21F 1/085; G21F 5/12

(57) ABSTRACT

Example systems and devices for housing radioactive targets are provided. The systems and devices for a special form capsule to house radioactive targets. In particular, the capsule includes a cylindrical housing having a first end and a base. A cap is fixed (e.g., welded) to the cylindrical housing at the first end. In some examples, an interface between the cylindrical housing and the cap is defined by a first groove circumferentially traversing an internal diameter of the cylindrical housing or the cap, the first groove to provide distance between any burrs and a target assembly contained within the housing.

### CROSS REFERENCE TO RELATED APPLICATIONS

This application is a Non-Provisional Patent application claiming priority to U.S. Provisional Patent Application No. 63/626,147 entitled “Special Form Capsule For Annular Target Assembly For Use In A Radiation Delivery System” filed Jan. 29, 2024, which is herein incorporated by reference in its entirety.

### FIELD OF THE DISCLOSURE

This disclosure relates generally to systems and devices for special form capsules to house radioactive targets and, more particularly, to systems and devices to annular target assemblies containing radioactive targets for use in a radiation delivery process in a radiation delivery system.

### BACKGROUND

Radioisotope sources, such as radioactive disks, are useful in a variety of industrial application. A radioisotope projector can be used to detect structural damage to metal parts, for example. Irradiation of such radioisotope sources requires specialized equipment and training, and can be a costly process. Further, transportation of irradiated sources requires specific procedures be followed, and specialized containment equipment used to handle and transport the radioisotope sources. Thus, systems and devices that mitigate damage to the transported radioisotope sources is desirable.

### SUMMARY

Systems and devices for special form capsules for housing annular target assemblies for use in a radiation delivery system are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1A illustrates an example special form capsule, in accordance with aspects of this disclosure.

FIG. 1B illustrates a cross-sectional block diagram of the example special form capsule of FIG. 1A, in accordance with aspects of this disclosure.

FIGS. 1C and 1D illustrate exploded and cross-sectional views of the example special form capsule of FIG. 1A, in accordance with aspects of this disclosure.

FIGS. 2A to 2C illustrate cross-sectional block diagram of other example special form capsules, in accordance with aspects of this disclosure.

FIG. 3 illustrates a perspective view of an example special form capsule, in accordance with aspects of this disclosure.

FIGS. 4A and 4B illustrate an example target assembly, in accordance with aspects of this disclosure.

The figures are not necessarily to scale. Wherever appropriate, similar or identical reference numerals are used to refer to similar or identical components.

### DETAILED DESCRIPTION

Disclosed systems and devices for a special form capsule to house radioactive targets. In particular, the capsule includes a cylindrical housing having a first end and a base. A cap is fixed (e.g., welded) to the cylindrical housing at the first end. In some examples, an interface between the cylindrical housing and the cap is defined by a first groove radially traversing an internal diameter of the cylindrical housing or the cap, the first groove to provide distance between any burrs and a target assembly contained within the housing.

In some example, one or more inserts (e.g., shell or bumper) are arranged within the cylindrical housing to prevent the target assembly within the housing from making contact with a portion of an internal surface of the housing.

Radioisotope sources, such as Iridium-192 (Ir-192), are used as a source of gamma radiation for industrial applications, including industrial gamma radiography on materials such as castings, forgings, and weld defects. Suitable materials include concrete, steel, lead, tungsten, or others.

Natural and enriched Iridium-192 sources are constructed using iridium targets (e.g., metal discs or pellets, often of a uniform size), and housed and/or transported in a welded stainless steel capsule. Moreover, utilizing enriched Ir-192 produces smaller focal sizes for optimum image quality for industrial imaging processes.

Handling, housing, transporting, and irradiating an iridium target requires specialized techniques and equipment. In some examples, irradiating an iridium target (or a plurality of targets) is performed in a radiation delivery system. The system exposes the targets to neutron radiation, which activates the inactive iridium-191 (Ir-191) within the target to become Ir-192.

Radiation delivery systems are typically constructed from materials such as graphite and aluminum which do not activate to long-lived radioactive isotopes. Radiation-compatible materials are not always compatible with standard construction materials used in special form transport container construction under elevated temperatures defined as hypothetical accident conditions.

To increase the efficiency of such an operation, disclosed are target assemblies that increase a number of targets that can be arranged around an outer diameter of a target core. Multiple examples are provided, with specific features which may offer benefits for different applications. Further, the target assemblies can be arranged on a support configured for insertion in the radiation delivery system. The target assemblies and support maximize the number of targets being irradiated in a single radiation delivery operation, as well as provide enhanced and/or expanded cooling options during such an operation. Moreover, the target assemblies can be stored within a special form capsule while each target is separately mounted on the target core, resulting in a straightforward process and system to package, handle and/or transport the targets.

Special form materials include radioactive isotopes that require additional protections when being handled and transported. One way to ensure proper handling is enclosing the radioactive isotopes in sealed special form capsules (SFC). SFCs are designed to withstand extreme temperatures and kinetic damage, to ensure that, while the source is within the SFC, the immediate environment is not exposed to contamination with radiative materials from the source. Regulations require that the package protect its contents and maintain containment under punishing conditions, which might be encountered during transportation.

The materials intended for encapsulation by the SFCs include solid, such as metallic, sources. In general, SFCs are suitable to house and transport a variety of radioactive sources, including alpha- and gamma-emitting isotopes, such as Ir-192.

SFCs are sealed to ensure neither radiation nor the radioactive sample itself leaks from the SFC. Thus, a SFC comprising a housing and cap is often welded closed, and tested to ensure a hermetic seal of the contents.

To retrieve the radioactive sample, the fully-sealed SFC is typically cut open, such as with a pipe cutter. However, the cutting process tends to provoke minor damage to the walls of the housing and/or cap. As a result, edges and/or burrs may extend into a chamber of the SFC that contains the target assembly. The target assembly, and the targets (e.g., radioactive samples), are then potentially subjected to damage, which may result in a damaged and/or an unusable target or target assembly.

Advantageously, use of the disclosed SFC mitigates the chance that the target and/or target assembly will come into contact with edges or burrs at the interface.

In disclosed examples, a capsule for housing radioactive targets includes a cylindrical housing having a first end and a base; a cap fixed to the cylindrical housing at the first end; and one or more inserts arranged within the cylindrical housing to prevent a target assembly within the housing from making contact with a portion of an internal surface of the housing.

In some examples, the cylindrical housing further comprising an internal chamber, wherein the insert includes one or more bumpers arranged within the chamber to support the target assembly.

In some examples, the capsule further includes a shell arranged within the housing such that a gap exists between an external diameter of the shell and the internal diameter of the wall of the capsule.

In some disclosed examples, a capsule for housing radioactive targets includes a cylindrical housing having a first end and a base; and a cap fixed to the cylindrical housing at the first end, wherein an interface between the cylindrical housing and the cap is defined by a first groove circumferentially traversing an internal diameter of the cylindrical housing or the cap.

In some examples, the interface is further defined by a second groove circumferentially traversing an external diameter of the cylindrical housing or the cap.

In examples, the first groove and the second groove are axially aligned about the cylindrical housing or the cap.

In examples, the cylindrical housing or the cap are formed of a metallic material.

In examples, the metallic material comprises titanium.

In examples, an inner diameter of the capsule is larger than an outer diameter of a target core configured to support a plurality of radioactive targets.

In some examples, an inner diameter of the capsule is larger than an outer diameter of a target sleeve configured to surround the target core.

In some examples, the cap further comprises an internal portion extending from a top end of the cap toward an interior of the capsule.

In some examples, the cap further includes a channel between an internal diameter of the cap and an external diameter of the internal portion.

In some examples, the cap is welded to the housing.

In some disclosed examples, a capsule for housing radioactive targets include a cylindrical housing having a first end and a base; a cap fixed to the cylindrical housing at the first end; and an extension to provide receive a tool to handle the capsule or remove the cap.

In some examples, the extension is magnetized or ferromagnetic.

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

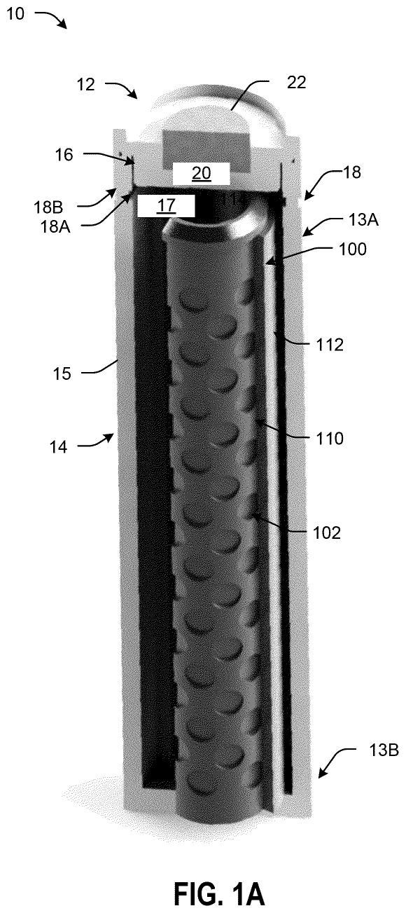

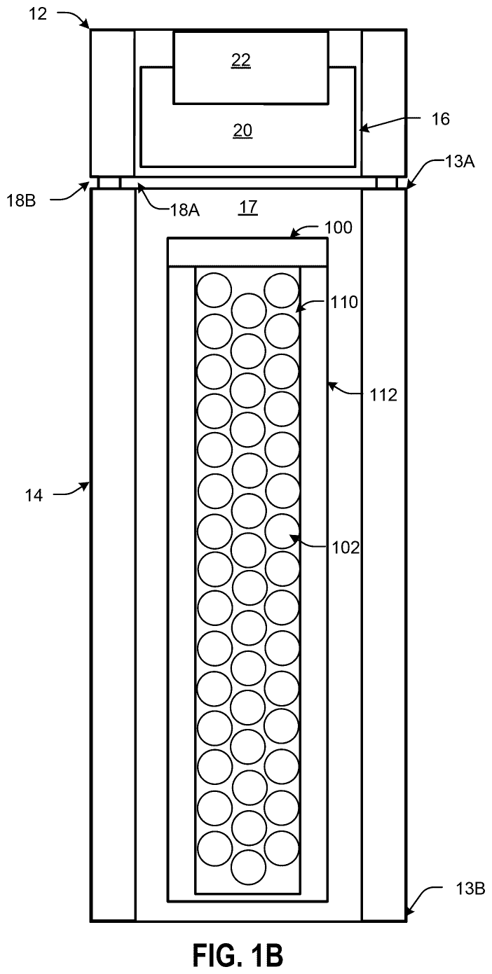

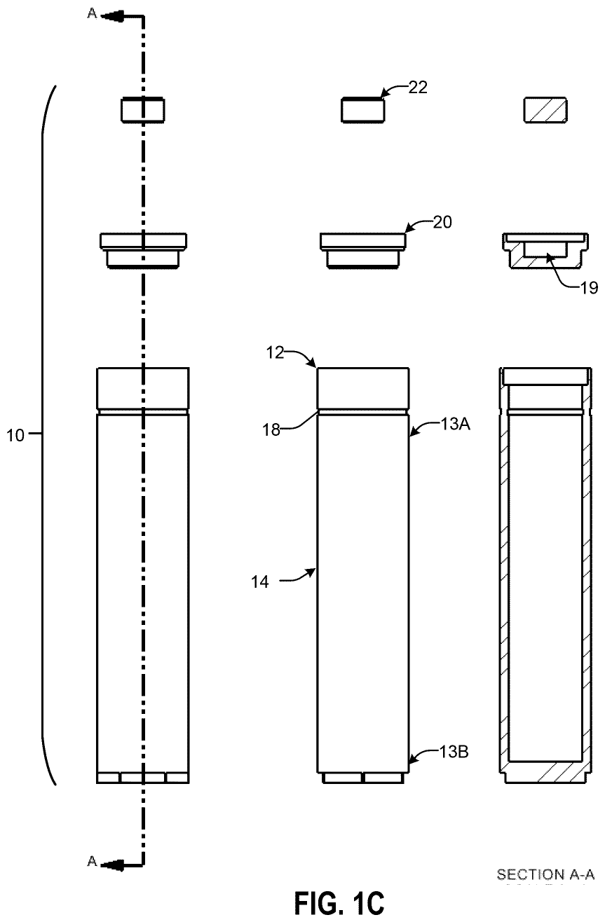

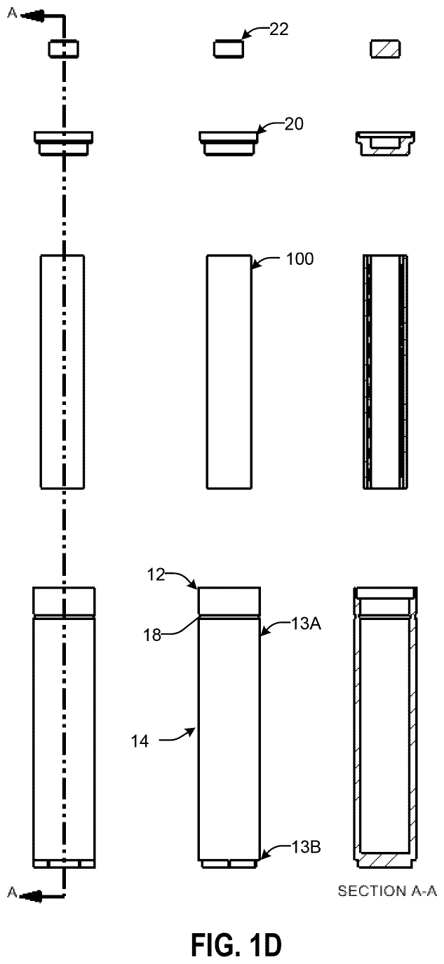

Turning to the figures, FIG. 1 illustrates an example special form capsule (SFC) 10 for housing radioactive targets. As shown, the capsule 10 includes a cylindrical housing 14 having a first end 13A and a base 13B. The first end 13A is open and configured to receive a cap 12. The cap 12 can be placed on the cylindrical housing and fixed at the first end. An interface 18 between the cylindrical housing and the cap is defined by one or more groves. For example, a first groove 18A circumferentially traverses an internal diameter or surface of a wall 15 the cylindrical housing or the cap, and a second groove 18B circumferentially traverses an external diameter or surface of the wall 15 the cylindrical housing 14 and/or the cap 12.

The cap 12 includes an internal portion 20 extending from a top end of the cap 12 toward the interior chamber 17 of the housing 14. In some examples, a channel 16 is provided between an internal diameter of the cap 12 and an external diameter of the internal portion 20.

FIGS. 1A and 1B show a target assembly 100 housed within the SFC 10. Here, the target assembly 100 includes a target core 110 designed to fit within a target sleeve 112. As shown, an inner diameter of the housing 14 is larger than an outer diameter of the target sleeve 112 and target assembly 100. Thus, the target assembly is surrounded by the housing 14.

The assembly 100 fits within the chamber 17, and may be arranged to float within the chamber or fixed at one end or another, such as by a fastener, bumper, etc.

In some examples, the cap 12 includes an extension 22 includes one or more devices to aid in handling, attracting, and/or manipulating the cap 12. The example extension 22 may be formed of a magnetic material to cause the cap 12 to be manipulable by an external magnet, and/or may include one or more threads, hooks, pins, grooves, and/or knobs, as a list of non-limiting examples.

FIG. 1B illustrates a cross-sectional view of the example SFC 10 of FIG. 1A in block form. As shown, the first groove 18A and the second groove 18B are aligned about the cylindrical housing 14 or the cap 12. In some examples, the first and second grooves do not align through the wall. In some examples, the first and second grooves are of a common height and depth. In some examples, one of the first or second grooves has a first height and/or depth, and the other groove has a second, different height and/or depth. For instance, the depth and/or height of the first groove 18A could be greater than the second groove 18B, such that any burrs from cutting during an opening operation are less likely to extend into an internal chamber 17 of the SFC 10.

FIGS. 1C and 1D illustrate exploded and cross-sectional views of the example SFC 10 of FIG. 1A. As shown in FIG. 1C, the SFC 10 is configured to receive the internal portion 20 into the cap 12, which can be sealed by welding. The extension 22 fits into a void 19 within the internal portion 20, and can similarly be fused or otherwise fastened to the internal portion 20. FIG. 1D another view of the example SFC 10, with the target assembly 100 shown.

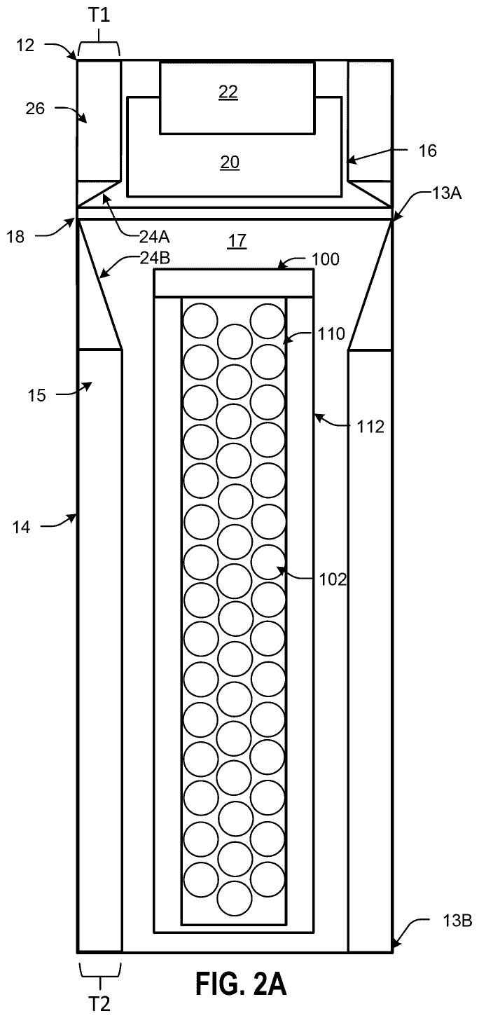

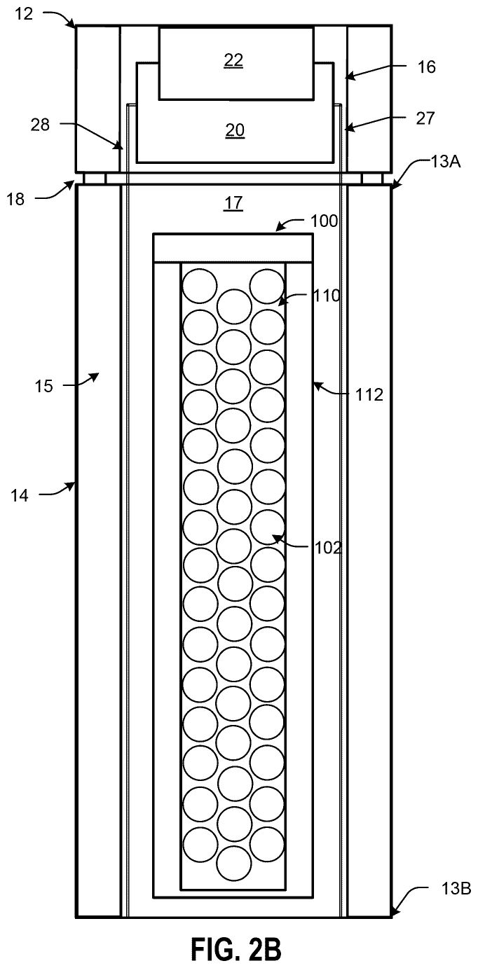

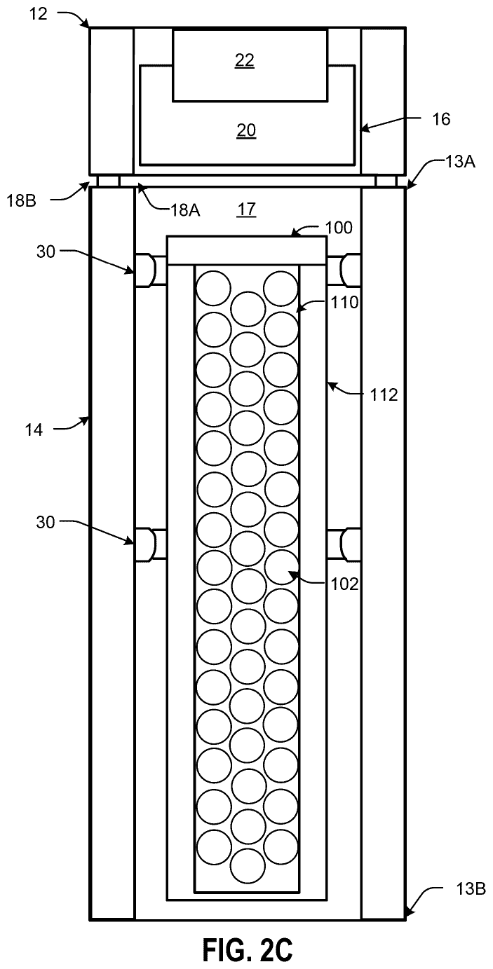

FIG. 2A illustrates a cross-sectional view of another example SFC. As shown, a wall 26 of the cap 12 includes an angled surface 24A. The angled surface 24A causes the wall 26 to be at a minimum at the interface 18, and then widens to a thickness T1 of the wall 26. Similarly, the wall 15 of the housing 14 includes an angled surface 24B. The angled surface 24B causes the wall 15 to be at a minimum at the interface 18, and then widens to a thickness T2. The space created within the SFC 10 by the angled surfaces similarly serves to put distance between the target assembly 100 and any burrs resulting from a cutting operation, as explained herein.

FIG. 2B illustrates a cross-sectional view of another example SFC. As shown, a protective shell 27 can be inserted into the SFC 10, surrounding the target assembly 100. In some examples, the shell 27 extends from the housing 14, past the interface 18, and into an interior portion of the cap 12 (e.g., the gap 16). The shell 27 can be dimensioned and arranged such that a gap 28 exists between an external diameter of the shell 27 and the internal diameter of the wall 15 of the SFC 10. While opening the SFC 10, any material creating a burr would be confined to the region defined by the gap, allowing the target assembly 100 to be safely removed without the threat of damage from the burrs.

FIG. 2C illustrates a cross-sectional view of yet another example SFC. As shown, one or more bumpers 30 (e.g., grommets, rings, extensions, protrusions, etc.), are arranged on an internal surface of the wall 15 within the chamber 17. The bumpers 30 have a smaller diameter than that of the housing 14, limiting movement of the target assembly 100 as it is being inserted and/or removed from the housing 14. Thus, distance is maintained within the SFC 10 between the target assembly 100 and any burrs resulting from a cutting operation.

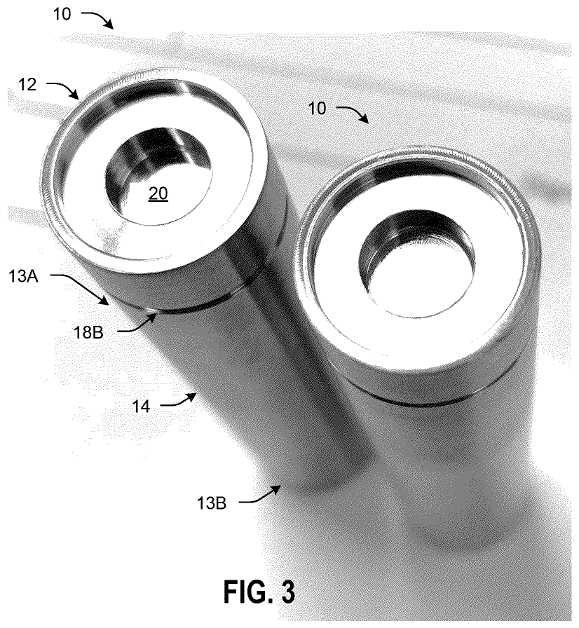

FIG. 3 illustrates a perspective view of example SFCs 10. The example SFC 10, housing 14 and/or cap 12 are illustrated as being generally cylindrical with a substantially annular profile. However, the SFC 10, housing 14 and/or cap 12 may have a rectangular, triangular, hexagonal, or other geometric profile. In some examples, the profile has an irregular profile, such as with one flat surface, to accommodate a differently sized or shaped of target assembly.

Further, one or more materials can be employed for the disclosed SFC 10, housing 14 and/or cap 12. For example, each of the SFC 10, housing 14 and/or cap 12 can be formed of a metallic material, such as titanium, although other metallic and/or non-metallic materials may be suitable.

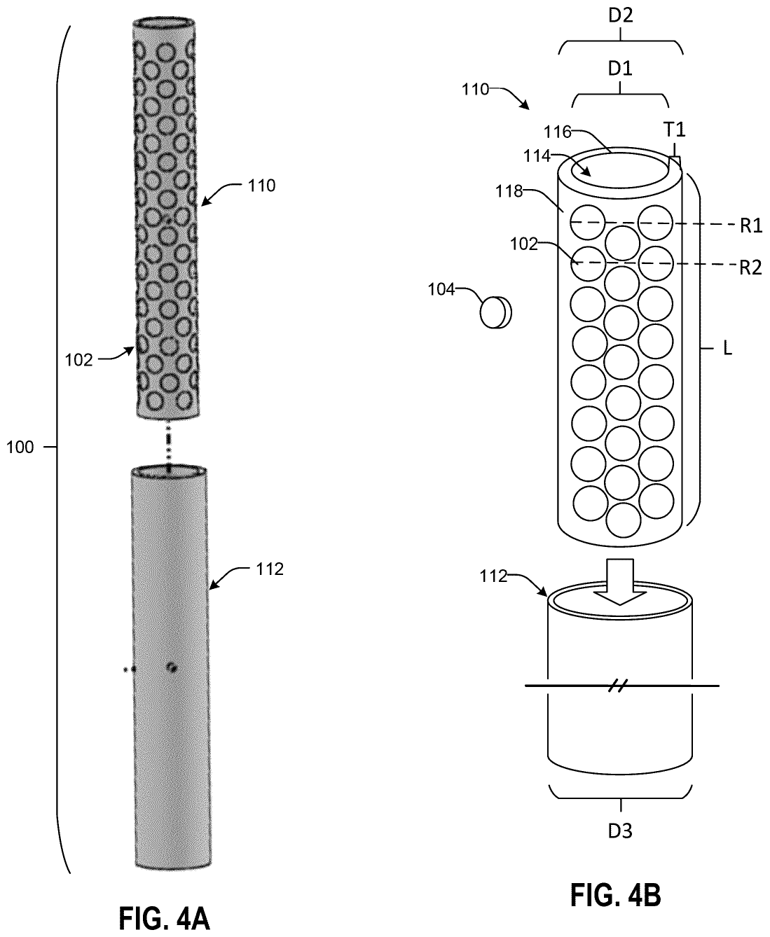

FIGS. 4A and 4B illustrate example target assemblies 100 that includes a target core 110 designed to fit within a target sleeve 112. The target assembly 100 is then configured to be inserted into the SFC 10 described with reference to FIGS. 1-3. Example target core 110 has a generally annular shape, with a central core 114 extending lengthwise through the target core 110, the central core 114 having an inner diameter D1. An external surface 118 of the target core 110 has an external diameter D2, with the difference between the inner diameter D1 and the outer diameter D2 generally corresponding to a wall thickness T1 of the target core 110.

The target core 110 has a plurality of recesses 102 designed to support a target 104. As shown, one or more of the recesses 102 can be fitted with a target. The recesses 102 are arranged in one or more patterns about the external surface 118, designed to maximize a number of targets that can be supported by the target core 110.

The outer diameter D3 of the sleeve 112 is dimensioned to fit within the housing 14.

One or more materials can be employed for the disclosed target assembly and/or the assembly support. For example, each of the annular core, the cylindrical sleeve, and the support can be formed of a metallic material, such as aluminum or titanium. In some examples, one or more of the features can be formed of graphite or a ceramic.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A capsule for housing radioactive targets comprising:
a cylindrical housing having a first end and a base; and
a cap fixed to the cylindrical housing at the first end; and
one or more inserts arranged within the cylindrical housing to prevent a target assembly within the housing from making contact with a portion of an internal surface of the housing.

2. The capsule of claim 1, wherein the cylindrical housing further comprising an internal chamber, wherein the insert includes one or more bumpers arranged within the chamber to support the target assembly.

3. The capsule of claim 1, further comprising a shell arranged within the housing such that a gap exists between an external diameter of the shell and the internal diameter of the wall of the capsule.

4. A capsule for housing radioactive targets comprising:
a cylindrical housing having a first end and a base; and
a cap fixed to the cylindrical housing at the first end, wherein an interface between the cylindrical housing and the cap is defined by a first groove circumferentially traversing an internal diameter of the cylindrical housing or the cap.

5. The capsule of claim 4, wherein the interface is further defined by a second groove circumferentially traversing an external diameter of the cylindrical housing or the cap.

6. The capsule of claim 5, wherein the first groove and the second groove are aligned about the cylindrical housing or the cap.

7. The capsule of claim 4, wherein the cylindrical housing or the cap are formed of a metallic material.

8. The capsule of claim 7, wherein the metallic material comprises titanium.

9. The capsule of claim 8, wherein an inner diameter of the capsule is larger than an outer diameter of a target core configured to support a plurality of radioactive targets.

10. The capsule of claim 4, wherein an inner diameter of the capsule is larger than an outer diameter of a target sleeve configured to surround the target core.

11. The capsule of claim 4, wherein the cap further comprises an internal portion extending from a top end of the cap toward an interior of the capsule.

12. The capsule of claim 11, wherein the cap further includes a channel between an internal diameter of the cap and an external diameter of the internal portion.

13. The capsule of claim 4, wherein the cap is welded to the housing.

14. A capsule for housing radioactive targets comprising:
a cylindrical housing having a first end and a base;
a cap fixed to the cylindrical housing at the first end; and
an extension to provide receive a tool to handle the capsule or remove the cap.

15. The capsule of claim 14, wherein the extension is magnetized.
